(19) United States
(12) Patent Application Publication
(10) Pub. No.: US 2023/0268486 A1
(43) Pub. Date: Aug. 24, 2023

(54) POSITIVE ELECTRODE COMPOSITE MATERIAL FOR LITHIUM IRON PHOSPHATE SECONDARY BATTERY AND LITHIUM IRON PHOSPHATE SECONDARY BATTERY

(71) Applicant: CONTEMPORARY AMPEREX TECHNOLOGY CO., LIMITED, Ningde (CN)

(72) Inventors: Wei ZHONG, Ningde (CN); Xiaowen ZHANG, Ningde (CN); Pengcheng QIN, Ningde (CN); Buxuan BAI, Ningde (CN)

(21) Appl. No.: 18/309,446

(22) Filed: Apr. 28, 2023

Related U.S. Application Data
(63) Continuation of application No. PCT/CN2022/072028, filed on Jan. 14, 2022.

(51) Int. Cl. H01M 4/36; H01M 4/58; H01M 4/04; H01M 10/052

(52) U.S. Cl. CPC H01M 4/364; H01M 4/0404; H01M 4/5815; H01M 4/5825; H01M 10/052; H01M 2004/028

(57) ABSTRACT

A positive electrode composite material includes a first type of material and at least one of a second type of material or a third type of material. The first type of material is a lithium iron phosphate material. The second type of material is AB_{b}, where A is at least one selected from Fe, Mn, Co, Ni, Ti, V, Nb, Ta, Zr, Hf, Cr, Mo, W, Re, Pt, Sn, Pb, and Sb, B is any one selected from S and Se, and a value of b is in a range of 1-4. The third type of material is a two-dimensional metal carbide, nitride, or carbonitride MXene material of formula Mₙ₊₁Xₙ or Mₙ₊₁XₙTₓ, where M is a transition metal element, X is C element and/or N element, Tₓ represents a surface functional group including -O, —OH, -Cl, or -F. The third type of material has a layered structure, and n represents a number of layers and n = 1, 2, or 3.

### CROSS-REFERENCE TO RELATED APPLICATION

This application is a continuation of International Application No. PCT/CN2022/072028, filed on Jan. 14, 2022, the entire content of which is incorporated herein by reference.

### TECHNICAL FIELD

The present disclosure relates to the technical field of lithium batteries, and in particular to a positive electrode composite material for a lithium iron phosphate secondary battery, a positive electrode for a lithium iron phosphate secondary battery, a lithium iron phosphate secondary battery, a battery module, a battery pack and a power consuming device.

### BACKGROUND ART

Lithium iron phosphate materials have the characteristics such as good safety performance, excellent cycling performance, environmental friendliness, and extensive sources of raw materials. In these materials, lithium, iron, and phosphorus all are elements with abundant reserves on the earth, especially iron-based materials, which have wide sources and low price, have been recognized as the first choice for the positive electrode material for the new generation of lithium ion batteries, and have become the key research and development direction of main developed countries in the world today.

A lithium iron phosphate battery has the following advantages: 1. the service life thereof is ultra-long, wherein a capacity retention rate after 2000 cycles is 80% or more; 2. the use thereof is safe; since the lithium iron phosphate material has a olivine structure and is not easy to decompose at a high temperature, same is more stable than lithium cobaltate and lithium manganate materials; 3. it has no memory effect; and 4. it is green and environmentally friendly. Therefore, a lithium iron phosphate battery is particularly suitable for use as a traction battery, and has been widely developed and applied in electric tools, energy storage and electric vehicles in recent years.

However, the lithium iron phosphate battery has a relatively poor low-temperature performance. Various methods have been used to improve the low-temperature performance of lithium iron phosphate, such as to improve the ionic and electronic conductivity by doping at lithium sites, iron sites or even at the phosphoric acid sites, to control the effective reaction area by improving the particle size and morphology of primary particles or secondary particles, and to increase the electronic conductivity by adding an additional conductive agent, but the inherent characteristics of the lithium iron phosphate material, such as slow lithium ion diffusion at a low temperature and serious solid phase diffusion and cumulative polarization under a long pulse, determine that the low-temperature performance thereof is inferior to that of other positive electrode materials (e.g., lithium manganate).

A lithium iron phosphate battery has been applied to different fields, but it has relatively poor performance when being used in a low temperature environment. The discharge capacity thereof at -20° C. is only about 30% of that at normal temperature, which limits the application thereof in cold regions such as the north. This is also a major obstacle to the promotion and use thereof as a traction battery; so it is crucial to improve the low-temperature performance of lithium iron phosphate batteries.

### SUMMARY

The objective of the present disclosure is to improve the low-temperature performance of a lithium iron phosphate battery and provide a low-temperature performance improved lithium iron phosphate battery.

A first aspect of the present disclosure provides a positive electrode composite material for a lithium iron phosphate secondary battery, comprising: a first type of material, which is a lithium iron phosphate material; and a second type of material and/or a third type of material, wherein the second type of material is AB_{b}, in which A is at least one selected from Fe, Mn, Co, Ni, Ti, V, Nb, Ta, Zr, Hf, Cr, Mo, W, Re, Pt, Sn, Pb and Sb, B is any one selected from S and Se, and a value of b is in a range of 1-4; the third type of material is a two-dimensional metal carbide, nitride or carbonitride MXene material of formula Mₙ₊₁Xₙ or Mₙ₊₁XₙTₓ, wherein M is a transition metal element, X is C element and/or N element, Tₓ represents a surface functional group -O, —OH, -Cl, or -F, and the third type of material has a layered structure, and n represents the number of layers and n = 1, 2 or 3.

As to the positive electrode composite material for a lithium iron phosphate secondary battery provided by the present disclosure, in some embodiments, the positive electrode composite material comprises the first type of material and the second type of material, or the positive electrode composite material comprises the first type of material and the third type of material, or the positive electrode composite material comprises the first type of material, the second type of material and the third type of material. In some embodiments, the positive electrode composite material comprises a composite of the second type of material and the third type of material.

In the positive electrode composite material for a lithium iron phosphate secondary battery provided by the present disclosure, in some embodiments, the second type of material is at least one selected from TiS₂, VSe₂, TiSe₂, VS₂, NbS₂, NbSe₂, and TaS₂. In some embodiments, the third type of material is Ti₃C₂Tₓ or Ti₃C₂.

In the positive electrode composite material for a lithium iron phosphate secondary battery provided by the present disclosure, in some embodiments, the composite of the second type of material and the third type of material is NbS₂—Ti₃C₂, TiS₂—Ti₃C₂ or VS₂—Ti₃C₂.

In the positive electrode composite material for a lithium iron phosphate secondary battery provided by the present disclosure, in some embodiments, the total content of the second type of material and/or the third type of material is 1-20% by weight, in some embodiments 3-15% by weight, relative to the total weight of the positive electrode composite material.

In the positive electrode composite material for a lithium iron phosphate secondary battery provided by the present disclosure, the second type of material may be composited with graphene.

In the positive electrode composite material for a lithium iron phosphate secondary battery provided by the present disclosure, the lithium iron phosphate material is at least one selected from LiFePO₄, doped LiFePO₄, carbon-coated LiFePO₄ or doped and carbon-coated LiFePO₄.

A second aspect of the present disclosure provides a positive electrode for a lithium iron phosphate secondary battery, comprising: a positive electrode current collector, and a positive electrode film which is provided on at least one surface of the positive electrode current collector and comprises a positive electrode composite material, wherein the positive electrode composite material is the positive electrode composite material according to the first aspect of the present disclosure.

A third aspect of the present disclosure provides a lithium iron phosphate secondary battery, comprising a positive electrode for a lithium iron phosphate secondary battery of the second aspect of the present disclosure.

A fourth aspect of the present disclosure provides a battery module, comprising a lithium iron phosphate secondary battery of the third aspect of the present disclosure.

A fifth aspect of the present disclosure provides a battery pack, comprising a battery module of the fourth aspect of the present disclosure.

A sixth aspect of the present disclosure provides a power consuming device, comprising at least one of a lithium iron phosphate secondary battery of the third aspect of the present disclosure, a battery module of the fourth aspect of the present disclosure, or a battery pack of the fifth aspect of the present disclosure.

Therefore, the positive electrode composite material of the present disclosure can improve the power performance of a lithium iron phosphate secondary battery in a low state of charge (SOC) at a low temperature.

### DETAILED DESCRIPTION OF EMBODIMENTS

In order to make the objectives, technical solutions and beneficial technical effects of the present disclosure clearer, the present disclosure will be described in detail below in conjunction with specific embodiments. It should be understood that the embodiments described in this specification are only for explaining the present disclosure, instead of intending to limit the present disclosure.

For the sake of brevity, merely some numerical ranges are explicitly disclosed herein. However, any lower limit may be combined with any upper limit to form a range that is not explicitly specified; and any lower limit may be combined with any other lower limit to form a range that is not explicitly specified, and any upper limit likewise may be combined with any other upper limit to form a range that is not explicitly specified. Further, although not explicitly specified, each point or single value between endpoints of a range is included in the range. Thus, each point or single value can be taken as a lower or upper limit to be combined with any other point or single value or with any other lower or upper limit to form a range that is not explicitly specified.

In the description herein, it should be noted that, unless otherwise stated, “no less than” and “no more than” means the endpoints preceded by them being included, and “more” in the phrase “one or more” means two or more.

The above summary of the present disclosure is not intended to describe every disclosed embodiment or every implementation of the present disclosure. The following description will illustrate exemplary embodiments in more detail. Throughout the present application, teachings are provided by means of a number of embodiments, which can be used in various combinations. In each instance, a list is only a representative group and should not be interpreted as exhaustive.

A first aspect of the present disclosure relates to a positive electrode composite material for a lithium iron phosphate secondary battery. The positive electrode composite material comprises a positive electrode active substance. In the present disclosure, the positive electrode active substance includes a lithium iron phosphate material (also referred as “a first type of material” herein). Herein, the lithium iron phosphate material may be selected from lithium iron phosphate (LiFePO₄, which may be referred to as LFP for short), doped LiFePO₄, carbon-coated LiFePO₄ or doped and carbon-coated LiFePO₄.

In the present disclosure, the positive electrode active substance may also further include other positive electrode active substances known in the art for use in a lithium ion secondary battery, for example, a lithium transition metal oxide (e.g., lithium nickel cobalt manganese oxide) and a modified compound thereof, and these positive electrode active substances may be used alone or in combination of two or more.

In an embodiment of the present disclosure, an appropriate amount of a material having a discharge voltage plateau lower than that of LFP (i.e., a second type of material and/or a third type of material) is added to the positive electrode composite material for a lithium iron phosphate secondary battery, which comprises a lithium iron phosphate material (a first type of material).

Specifically, the positive electrode composite material for a lithium iron phosphate secondary battery comprises: a first type of material, which is a lithium iron phosphate material; and a second type of material and/or a third type of material, wherein the second type of material is AB_{b}, in which A is at least one selected from Fe, Mn, Co, Ni, Ti, V, Nb, Ta, Zr, Hf, Cr, Mo, W, Re, Pt, Sn, Pb and Sb, B is any one selected from S and Se, and a value of b is in a range of 1-4; the third type of material is a two-dimensional metal carbide, nitride or carbonitride MXene material of formula Mₙ₊₁Xₙ or Mₙ₊₁XₙTₓ, wherein M is a transition metal element, X is C element and/or N element, Tₓ represents a surface functional group -O, —OH, -Cl, or -F, and the third type of material has a layered structure, and n represents the number of layers and n = 1, 2 or 3.

When an appropriate amount of a second type of material and/or a third type of material having a low voltage plateau is added to the positive electrode composite material, correspondingly, a voltage plateau at a relatively low voltage level is introduced into the whole discharge voltage distribution curve of the battery. When the discharge voltage distribution curve of the battery reaches the end of the higher voltage plateau of the positive electrode active material itself and then drops rapidly, the lower voltage plateau introduced based on the existence of the material having a low voltage plateau can slow down the voltage drop trend at the final stage of discharge.

At a low temperature, at the final stage of discharge of the battery, i.e. the battery is in a low state of charge (SOC), after the intercalation of lithium ions into LFP is completed during the discharge process of the battery, a large number of lithium ions may be intercalated into the second type of material and the third type of material since the second type of material and the third type of material have a lower voltage plateau than that of LFP, thereby maintaining the continuous discharge of the battery; therefore, the power performance of the battery in the low state of charge at a low temperature may be improved. When the lithium iron phosphate secondary battery according to the present disclosure is used in an electric vehicle, since the lithium iron phosphate secondary battery has improved power performance, it is beneficial to improve the accelerating ability of the whole vehicle at a low temperature, thus allowing the full utilization of the battery power even under a working condition at a low temperature.

In an embodiment of the present disclosure, the positive electrode composite material in some embodiments comprises both the second type of material and the third type of material; in some embodiments, the second type of material is composited with the third type of material.

The composite between the second type of material and the third type of material can be achieved by loading the second type of material in the layer of the third type of material. The composite of the second type of material and the third type of material can further enhance the improvement effect of power performance.

The third type of material MXene has a two-dimensional layered structure, the chemical structure on the surface thereof can be adjusted, and different MXene can provide different potential windows. Moreover, MXene has characteristics of a high specific surface area and a high electrical conductivity. A large specific surface area can provide more storage sites; and a good electrical conductivity is beneficial for electron transport. MXene has a relatively low potential barrier to lithium ion diffusion, and the layered structure thereof is conducive to the fast diffusion of lithium ions between layers, which can achieve the fast intercalation and deintercalation of lithium ions.

Compared with the use of a second type of material or a third type of material alone, the composite material of a second type of material and a third type of material can increase the specific surface area, which is beneficial to increase the contact area and adsorption capacity of lithium ions on the composite material, thus improving the lithium storage capacity; moreover, the composite material of the second type of material and the third type of material can prevent the agglomeration of the second type of material itself, the relatively weak interaction between layers and the surface functional group improve the intercalation reaction, and more marginal active sites are exposed, which can improve the migration rate of lithium ions, thus improving the power performance of the battery.

In an embodiment of the present disclosure, in some embodiments, the second type of material is at least one selected from TiS₂, VSe₂, TiSe₂, VS₂, NbS₂, NbSe₂, and TaS₂, and in some embodiments, the third type of material is Ti₃C₂Tₓ or Ti₃C₂.

In an embodiment of the present disclosure, in some embodiments, the composite of the second type of material and the third type of material is NbS₂—Ti₃C₂, or TiS₂—Ti₃C₂ or VS₂—Ti₃C₂.

In an embodiment of the present disclosure, the content of the second type of material and/or third type of material added should not be too low; otherwise, no obvious discharge plateau could be observed under the low state of charge of the battery, and the continuous discharge of the battery cannot be maintained at the final stage of discharge; their contents should not be too high either; otherwise, the overall capacity of the battery may be reduced due to the corresponding reduction of the content of the positive electrode active substances. The total content of the second type of material and third type of material added is in some embodiments 1-20% by weight, in some embodiments 3-15% by weight, relative to the total weight of the positive electrode composite material.

In an embodiment of the present disclosure, the surface of the second type of material may have an electrically conductive material coating layer, or the second type of material and a electrically conductive material are subjected to composite modification, thus improving the electrical conductivity. The electrically conductive material is in some embodiments graphene.

A second aspect of the present disclosure relates to a positive electrode for a lithium iron phosphate secondary battery, comprising: a positive electrode current collector, and a positive electrode film which is provided on at least one surface of the positive electrode current collector and comprises the above-mentioned positive electrode composite material.

A third aspect of the present disclosure relates to a lithium iron phosphate secondary battery, comprising a positive electrode for a lithium iron phosphate secondary battery of the second aspect of the present disclosure.

The structure and the preparation method of the lithium iron phosphate secondary battery according to the present disclosure are well-known per se. Generally, a lithium ion secondary battery comprises an outer package bag, and a cell and an electrolyte solution provided in the outer package bag, wherein the cell comprises a positive electrode film, a negative electrode film and a separator. In the lithium iron phosphate secondary battery according to the present disclosure, both the specific type and composition of the separator and electrolyte are not specifically limited, and can be selected according to actual requirements. Specifically, the separator may be selected from a polyethylene film, a polypropylene film, a polyvinylidene fluoride film, and a multi-layer composite film thereof.

As to the lithium iron phosphate secondary battery of the present disclosure, a solution of a lithium salt dissolved in an organic solvent is generally used as the non-aqueous electrolyte solution. The lithium salt is, for example, an inorganic lithium salt such as LiClO₄, LiPF₆, LiBF₄, LiAsF₆ and LiSbF₆, or an organic lithium salt such as LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (n ≥ 2), etc. The organic solvent used in the non-aqueous electrolyte solution is, for example, a cyclic carbonate ester such as ethylene carbonate, propylene carbonate, butylene carbonate, and vinylene carbonate; a chain carbonate ester, such as dimethyl carbonate, diethyl carbonate, and methyl ethyl carbonate; a chain ester such as methyl propionate; a cyclic ester such as γ-butyrolactone; a chain ether, such as dimethoxyethane, diethyl ether, diethylene glycol dimethyl ether, and triethylene glycol dimethyl ether; a cyclic ether, such as tetrahydrofuran and 2-methyltetrahydrofuran; nitriles, such as acetonitrile and propionitrile; or a mixture of these solvents.

The lithium iron phosphate secondary battery of the present disclosure is briefly described below.

First, a positive electrode film is prepared according to a conventional method in the art. Generally, in the positive electrode film, in addition to the above-mentioned positive electrode composite material, it is also necessary to add a conductive agent (e.g., Super P), a binder (e.g., PVDF), etc. Other additives can also be added as needed. Generally, these materials are mixed together and dispersed in a solvent (e.g., NMP), stirred until uniform and then evenly coated onto a positive electrode current collector, followed by drying to obtain a positive electrode film containing a positive electrode film layer. Materials, for example, a metal foil such as an aluminum foil, or a porous metal plate, can be used as the positive electrode current collector. In some embodiments, an aluminum foil is used as the positive electrode current collector.

The negative electrode film of the present disclosure can be prepared by a well-known method in the art. Generally, a negative electrode active material and materials such as an optional conductive agent (e.g., Super P), a binder (e.g., SBR), and other optional additives are mixed together and dispersed in a solvent (e.g., deionized water), stirred until uniform and then evenly coated onto a negative electrode current collector, followed by drying to obtain a negative electrode film containing a negative electrode film layer. Materials, for example, a metal foil such as a copper foil, or a porous metal plate, can be used as the negative electrode current collector. In some embodiments, a copper foil is used as the negative electrode current collector.

In the above-mentioned positive and negative electrode films, the percentage of the active substance in the positive and negative electrode film layers should not be too low; otherwise, it will results in a too low capacity; and the percentage of the active substance should not be too high either; otherwise, it would result in the reduction of the conductive agent and binder, which will reduce the electrical conductivity of the electrode film and the adhesion thereof to the current collector, thus reducing the electrical performance of the cell.

During the preparation of the positive and negative electrode films, the current collector may be coated on both sides or on one side.

Finally, the positive electrode film layer, the separator, and the negative electrode film layer are stacked in sequence, such that the separator is placed between the positive electrode film layer and the negative electrode film layer and plays a role of isolation, and then they are wound to obtain a bare cell; the bare cell is placed into an outer package and dried, then the electrolyte solution is injected, and the procedures such as vacuum encapsulation, standing, forming, and shaping are carried out to obtain a lithium iron phosphate secondary battery.

Other aspects of the present disclosure relate to a battery module, a battery pack, and a power consuming device. The lithium iron phosphate secondary battery of the present disclosure can form a battery module, and the battery module can form a battery pack. The power consuming device comprises at least one of a lithium iron phosphate secondary battery, a battery module or a battery pack provided by the present disclosure. The lithium iron phosphate secondary battery, the battery module or the battery pack may be used as a power supply or an energy storage unit of the power consuming device. The power consuming device may include a mobile device (e.g., a mobile phone, a tablet computer, a laptop computer, etc.), an electric vehicle (e.g., a pure electric vehicle, a hybrid electric vehicle, a plug-in hybrid electric vehicle, an electric bicycle, an electric scooter, an electric golf cart, an electric truck, etc.), an electric train, ship and satellite, an energy storage system, etc., but is not limited thereto.

### EXAMPLES

Hereinafter, the examples of the present disclosure will be explained. The examples described below are exemplary and are merely for explaining the present disclosure, and should not be construed as limiting the present disclosure. The examples in which specific techniques or conditions are not specified are based on the techniques or conditions described in documents in the art or according to the product introduction. The reagents or instruments used therein for which manufacturers are not specified are all conventional products that are commercially available. Various parameters involved in the present specification have common meanings well-known in the art and can be measured according to methods well-known in the art. For example, a test may be performed according to the method given in the examples of the present disclosure.

In the examples of the present disclosure, the positive electrode film is prepared in a conventional manner, wherein the positive electrode film comprises a positive electrode composite material, conductive carbon and a binder.

The positive electrode composite material comprises a positive electrode active substance and an additive. Specifically, the positive electrode active substance is LiFePO₄ (i.e., the first type of material), and the additive is AB_{b} (i.e., the second type of material) and/or the MXene material (i.e., the third type of material). In the positive electrode composite material, the total content of the additive is 1-20% by weight (relative to the total weight of the positive electrode composite material).

The positive electrode active substance is 85% of the total mass of the positive electrode coating, and the compacted density is 2.4 g/cm³. A conventional graphite negative electrode film is used as the negative electrode, a conventional electrolyte solution (1 mol/L of LiPF₆ dissolved in an organic solvent (EC/DMC/EMC = 1/1/1 (mass ratio))) and a separator (a polyethylene film with a thickness of 14 µm) are used, and a lithium iron phosphate secondary battery with a wound structure is prepared and assembled according to conventional methods.

The source of the MXene material is not limited. It may be a commercially available product which is used directly or can be homemade. For example, MXene-Ti₃C₂Tₓ can be obtained by directly buying a commercially available product or can be prepared by the following method: at room temperature, 1 g Ti₃AlC₂ is placed into a 6 mol/L aqueous solution of HF (10 ml) for 7-10 days, washed with deionized water, then vacuum filtered, and dried at 60° C. for 12 hours.

As an example of the composite of the second type of material and the third type of material, given that VS₂ is easier to prepare and the voltage plateau of VS₂ is closer to that of LiFePO₄, which has little influence on the overall change of the lower limit voltage of the battery, VS₂ is used as the second type of material. Correspondingly, the composite of the second type of material and the third type of material is VS₂—Ti₃C₂ at a molar ratio of 2 : 1.

The preparation steps for VS₂—Ti₃C₂ (at a molar ratio of 2 : 1) are as follows: the two-dimensional material MXene-Ti₃C₂ is prepared by a known chemical liquid etching process, and then VS₂ is loaded in the layer of MXene-Ti₃C₂ at the above-mentioned molar ratio. Specifically, first, MXene-Ti₃C₂ is placed in distilled water or deionized water for sonication for 30-60 minutes and dispersed until uniform, then VS₂ is added and stirred for 2-6 hours, the mixed solution is transferred into a hydrothermal reaction kettle for reaction at 180-250° C. for 20-40 hours, and after the reaction is completed, the mixture is washed to obtain a precipitate, which is dried in a vacuum oven for later use.

NbS₂—Ti₃C₂ (at a molar ratio of 2 : 1) and TiS₂—Ti₃C₂ (at a molar ratio of 2 : 1) are prepared by the same method.

### Example 1

The positive electrode active substance is LiFePO₄, and the additive is the second type of material, i.e. TiS₂. The content of TiS₂ is 3%, relative to the total weight of the two.

### Example 2

The positive electrode active substance is LiFePO₄, and the additive is the second type of material, i.e. VSe₂. The content of VSe₂ is 3%, relative to the total weight of the two.

### Example 3

The positive electrode active substance is LiFePO₄, and the additive is the second type of material, i.e. TiSe₂. The content of TiSe₂ is 3%, relative to the total weight of the two.

### Example 4

The positive electrode active substance is LiFePO₄, and the additive is the second type of material, i.e. VS₂. The content of VS₂ is 3%, relative to the total weight of the two.

### Example 5

The positive electrode active substance is LiFePO₄, and the additive is the second type of material, i.e. NbSe₂. The content of NbSe₂ is 3%, relative to the total weight of the two.

### Example 6

The positive electrode active substance is LiFePO₄, and the additive is the second type of material, i.e. TaS₂. The content of TaS₂ is 3%, relative to the total weight of the two.

### Example 7

The positive electrode active substance is LiFePO₄, and the additive is the third type of material, i.e. Ti₃C₂Tₓ. The content of Ti₃C₂Tₓ is 3%, relative to the total weight of the two.

### Example 8

The positive electrode active substance is LiFePO₄, and the additive is the composite of the second type of material NbS₂ and the third type of material Ti₃C₂ at a molar ratio of 2 : 1. The total content of the additive is 3%, relative to the total weight of the two.

### Example 9

The positive electrode active substance is LiFePO₄, and the additive is the composite of the second type of material TiS₂ and the third type of material Ti₃C₂ at a molar ratio of 2 : 1. The total content of the additive is 3%, relative to the total weight of the two.

### Example 10

The positive electrode active substance is LiFePO₄, and the additive is the composite of the second type of material VS₂ and the third type of material Ti₃C₂ at a molar ratio of 2 : 1. The total content of the additive is 3%, relative to the total weight of the two.

### Example 11

The positive electrode active substance is LiFePO₄, and the additive is the composite of the second type of material VS₂ and the third type of material Ti₃C₂ at a molar ratio of 2 : 1. The total content of the additive is 1%, relative to the total weight of the two.

### Example 12

The positive electrode active substance is LiFePO₄, and the additive is the composite of the second type of material VS₂ and the third type of material Ti₃C₂ at a molar ratio of 2 : 1. The total content of the additive is 10%, relative to the total weight of the two.

### Example 13

The positive electrode active substance is LiFePO₄, and the additive is the composite of the second type of material VS₂ and the third type of material Ti₃C₂ at a molar ratio of 2 : 1. The total content of the additive is 15%, relative to the total weight of the two.

### Example 14

The positive electrode active substance is LiFePO₄, and the additive is the composite of the second type of material VS₂ and the third type of material Ti₃C₂ at a molar ratio of 2 : 1. The total content of the additive is 20%, relative to the total weight of the two.

### Comparative Example

The positive electrode active substance is LiFePO₄, and the positive electrode composite material does not contain the second type of material and the third type of material.

### Performance Test

The corresponding low-temperature performance of the battery cells in examples 1-14 and the comparative example is tested.

The test method is as follows:

A cell in a specific state of charge (20% SOC) at a temperature of 25° C. is placed at -25° C. for discharging at a specific rate (0.7 C) for 180 s, wherein a lower limit voltage is 1.5 V.

On the basis that the cells of each example and the comparative example are converted to have the same capacity, the internal resistance of the cell is used to reflect the improvement in the discharge power of the cell of each example relative to the comparative example (without the addition of any second type of material and third type of material in the positive electrode material). Within the same voltage range and at the same current, the smaller the internal resistance of the cell, the greater the discharge power of the cell of the corresponding example.

The calculation method for the resistance of the cell is: (the voltage before discharging -the voltage after discharging)/current

The calculation method for the proportion of improvement in the discharge power is: (the internal resistance of the cell of the comparative example - the internal resistance of the cell of each example)/the internal resistance of the cell of the comparative example

The test results of examples 1-14 and comparative example are shown in Table 1.

TABLE 1

| No. | Second type of material and/or third type of material | Content of the second type of material and/or third type of material (wt%) | Internal resistance of cell (-25° C., 20% soc, 180 s) 0.7 C, lower limit voltage: 1.5 V | Proportion of improvement |
|---|---|---|---|---|
| Example 1 | TiS₂ | 3 | 10.07 | 31% |
| Example 2 | VSe₂ | 3 | 7.74 | 47% |
| Example 3 | TiSe₂ | 3 | 6.86 | 53% |
| Example 4 | VS₂ | 3 | 11.68 | 20% |
| Example 5 | NbSe₂ | 3 | 8.32 | 43% |
| Example 6 | TaS₂ | 3 | 10.66 | 27% |
| Example 7 | Ti₃C₂Tₓ | 3 | 10.95 | 25% |
| Example 8 | NbS₂—Ti₃C₂ (2 : 1) | 3 | 7.30 | 50% |
| Example 9 | TiS₂—Ti₃C₂ (2 : 1) | 3 | 8.61 | 41% |
| Example 10 | VS₂—Ti₃C₂ (2 : 1) | 3 | 9.49 | 35% |
| Example 11 | VS₂—Ti₃C₂ (2 : 1) | 1 | 14.16 | 3% |
| Example 12 | VS₂—Ti₃C₂ (2 : 1) | 10 | 7.59 | 48% |
| Example 13 | VS₂—Ti₃C₂ (2 : 1) | 15 | 6.72 | 54% |
| Example 14 | VS₂—Ti₃C₂ (2 : 1) | 20 | 6.42 | 56% |
| Comparative example | None | | 14.6 | |

With reference to table 1, it can be seen from the performance test results of examples 1-14 and comparative example that, the addition of the second type of material and/or the third type of material to the positive electrode composite material for a lithium iron phosphate secondary battery reduces the internal resistance of the cell, that is the discharge power is improved, relative to the comparative example without the addition of any second type of material and third type of material.

It can be seen from the comparison between examples 1-6 that, with the same addition amount, when TiSe₂ is added as the second type of material (example 3), the proportion of improvement in the discharge power is the largest. The reason is that the voltage plateau of the second type of material is an influential factor for the improvement in power performance. In the present disclosure, the low voltage plateau of the additive is in some embodiments at 3.22 V or less. The voltage plateau of TiSe₂ is in a range of 1.7-2.1 V, which is greatly different from that of LiFePO₄, and in some embodiments the second type of material is TiSe₂.

As can be seen from the comparison between example 4, example 7 and example 10, with the same addition amount, the composite of the second type of material and the third type of material (example 10) can reduce the internal resistance and improve the discharge power, relative to the use of the second type of material (example 4) or the third type of material (example 7) alone.

In addition, it can be seen from the comparison between examples 10-14 that, with the increase of the addition amount, the effect of reducing the internal resistance of the cell becomes better. However, when the content of the additive in the positive electrode composite material is 1% by weight (example 11), since the addition amount is too low, the reduction in the internal resistance of the cell is not obvious. Therefore, the addition amount of 1% by weight is not preferred. In addition, although the effect of reducing the internal resistance of the cell is the best when the addition amount is 20% by weight, the content of the positive electrode active substance is correspondingly reduced due to the relatively high additive content, which may influence the overall discharge capacity. Therefore, the additive content of 20% by weight is not preferred either.

The content of the additive in the present disclosure may be in a range of 1-20% by weight, in some embodiments, 3-15% by weight, and the optimal proportion is 15% by weight.

It should be noted that the present disclosure is not limited to the above embodiments. The above embodiments are exemplary only, and any embodiment that has substantially the same constitutions as the technical ideas and has the same effects within the scope of the technical solution of the present disclosure falls within the technical scope of the present disclosure. In addition, without departing from the gist of the present disclosure, various modifications that can be conceived by those skilled in the art to the embodiments, and other modes constructed by combining some of the constituent elements of the embodiments also fall within the scope of the present disclosure.

What is claimed is:

1. A positive electrode composite material, comprising:
a first type of material, which is a lithium iron phosphate material; and
at least one of a second type of material or a third type of material; wherein:
the second type of material is AB_{b}, wherein A is at least one selected from Fe, Mn, Co, Ni, Ti, V, Nb, Ta, Zr, Hf, Cr, Mo, W, Re, Pt, Sn, Pb, and Sb, B is any one selected from S and Se, and a value of b is in a range of 1-4; and
the third type of material is a two-dimensional metal carbide, nitride, or carbonitride MXene material of formula Mₙ₊₁Xₙ or Mₙ₊₁XₙT_{X}, wherein M is a transition metal element, X is C element and/or N element, Tₓ represents a surface functional group including -O, —OH, -Cl, or -F, the third type of material has a layered structure, and n represents a number of layers and n = 1, 2, or 3.

2. The positive electrode composite material according to claim 1, comprising the first type of material and the second type of material.

3. The positive electrode composite material according to claim 1, comprising the first type of material and the third type of material.

4. The positive electrode composite material according to claim 1, comprising the first type of material, the second type of material, and the third type of material.

5. The positive electrode composite material according to claim 4, comprising a composite of the second type of material and the third type of material.

6. The positive electrode composite material according to claim 5, wherein the composite of the second type of material and the third type of material is NbS₂—Ti₃C₂, TiS₂—Ti₃C₂, or VS₂—Ti₃C₂.

7. The positive electrode composite material according to claim 1, wherein the second type of material is at least one selected from TiS₂, VSe₂, TiSe₂, VS₂, NbS₂, NbSe₂, and TaS₂.

8. The positive electrode composite material according to claim 1, wherein the third type of material is Ti₃C₂Tₓ or Ti₃C₂.

9. The positive electrode composite material according to claim 1, wherein a total content of the at least one of the second type of material or the third type of material is 1-20% by weight, relative to a total weight of the positive electrode composite material.

10. The positive electrode composite material according to claim 1, wherein a total content of the at least one of the second type of material or the third type of material is 3-15% by weight, relative to a total weight of the positive electrode composite material.

11. The positive electrode composite material according to claim 1, wherein the second type of material is composited with graphene.

12. The positive electrode composite material according to claim 1, wherein the lithium iron phosphate material is at least one selected from LiFePO₄, doped LiFePO₄, carbon-coated LiFePO₄, or doped and carbon-coated LiFePO₄.

13. A positive electrode, comprising:
a positive electrode current collector; and
a positive electrode film provided on at least one surface of the positive electrode current collector and comprising a positive electrode composite material, wherein the positive electrode composite material comprises:
a first type of material, which is a lithium iron phosphate material; and
at least one of a second type of material or a third type of material; wherein:
the second type of material is AB_{b}, wherein A is at least one selected from Fe, Mn, Co, Ni, Ti, V, Nb, Ta, Zr, Hf, Cr, Mo, W, Re, Pt, Sn, Pb, and Sb, B is any one selected from S and Se, and a value of b is in a range of 1-4; and
the third type of material is a two-dimensional metal carbide, nitride, or carbonitride MXene material of formula Mₙ₊₁Xₙ or Mₙ₊₁XₙTₓ, wherein M is a transition metal element, X is C element and/or N element, Tₓ represents a surface functional group including -O, —OH, -Cl, or -F, the third type of material has a layered structure, and n represents a number of layers and n = 1, 2, or 3.

14. A lithium iron phosphate secondary battery, comprising:
a positive electrode comprising:
a positive electrode current collector; and
a positive electrode film provided on at least one surface of the positive electrode current collector and comprising a positive electrode composite material, wherein the positive electrode composite material comprises:
a first type of material, which is a lithium iron phosphate material; and
at least one of a second type of material or a third type of material; wherein:
the second type of material is AB_{b}, wherein A is at least one selected from Fe, Mn, Co, Ni, Ti, V, Nb, Ta, Zr, Hf, Cr, Mo, W, Re, Pt, Sn, Pb, and Sb, B is any one selected from S and Se, and a value of b is in a range of 1-4; and
the third type of material is a two-dimensional metal carbide, nitride, or carbonitride MXene material of formula Mₙ₊₁Xₙ or Mₙ₊₁XₙT_{X}, wherein M is a transition metal element, X is C element and/or N element, Tₓ represents a surface functional group including -O, —OH, -Cl, or -F, the third type of material has a layered structure, and n represents a number of layers and n = 1, 2, or 3.

15. A battery module, comprising the lithium iron phosphate secondary battery according to claim 14.

16. A battery pack, comprising the battery module according to claim 15.

17. A power consuming device, comprising the battery pack according to claim 16.

18. A power consuming device, comprising the battery module according to claim 15.

19. A power consuming device, comprising the lithium iron phosphate secondary battery according to claim 14.
